(19) United States
(12) Patent Application Publication
(10) Pub. No.: US 2006/0042321 A1
(43) Pub. Date: Mar. 2, 2006

(54) Integrated simulation fabrication and characterization of micro and nano optical elements

(76) Inventors: Aaron Lewis, Jerusalem (IL); Noel Axelrod, Jerusalem (IL); Sofia Kokotov, Maale Adumim (IL); Alexander Krol, Jerusalem (IL); Oleg Zhinoview, Jerusalem (IL); Ganila Zhinoview, Jerusalem (IL); Galina Fish, Jerusalem (IL); Andrei Ignatov, Jerusalem (IL); Rima Glazer, Jerusalem (IL); Eran Maayan, Jerusalem (IL)

Correspondence Address: JONES, TULLAR & COOPER, P.C., P.O. BOX 2266 EADS STATION, ARLINGTON, VA, 22202, US

(21) Appl. No.: 10/533,904

(22) PCT Filed: Nov. 6, 2003
(86) PCT No.: PCT/US03/32741

§ 371 Date: Sep. 27, 2005

(30) Foreign Application Priority Data
Nov. 6, 2002 (IL) 152675

(51) Int. Cl. G01N 23/00; C03B 37/00

(52) U.S. Cl. 65/378; 65/387; 65/425

(57) ABSTRACT

The invention is directed to a method for fabricating a micro or nano structure such as an optical waveguide incorporating an emitting surface in the form of a lens. The structure is fabricated on the basis of a theoretical simulation of the structure, with the parameters of the structure being characterized by geometric and light profiling using near-field and far-field monitoring. The results of the characterizing are compared iteratively with the simulation during fabrication.

This application claims the benefit of Israel Patent No. 152,675, filed Nov. 6, 2002, the disclosure of which is hereby incorporated herein by reference.

### FIELD OF THE INVENTION

The field of the invention is the fabrication of arbitrary micro and nano optical structures and devices as a result of the realization that integrated near-field/far-field optical imaging with on-line atomic force imaging and other scanned probe methods (SPM) can guide multistep processing of such optical elements. A crucial component in such processing is iterative theoretical simulations with constraints imposed by the near-field optical results. With such a combination of theory and near-field optical data together with SPM technology aided by new methods of highly accurate refractive index imaging, which is also a part of this invention, the order and the extent of multiple step processing can be guided to obtain optical solutions that could not be previously achieved or could not be achieved with the accuracy and the repeatability that is required by the high tolerance requirements of industry today.

The steps that have to be guided have previously been considered competing technologies for the production of integral fiber lenses or lenses with other waveguides or other micro and nano optical elements. These steps include either no tapering or tapering using pulling and/or mechanical and/or laser polishing and/or heating, with and/or without etching and/or writing and/or masking with or without imposed radiation and with or without photoresist and/or other similar procedures and/or imprinting and/or molding and/or deposition depending on the parameters of the micro and or nano optical structure that has to be achieved.

The synergistic interconnection between theory, where paraxial/far-field approximations fail, the near-field optical characterization and associated SPM methodology and the integrated production methodologies are an essential component of this patent. As a result arbitrary structures can be generated for waveguides, such as a glass fiber or a micropipette or a crystal fiber or other materials that act as a waveguide, or other structures that can be achieved for micro and nano optical objectives by controlled manipulation, molding or deposition of materials to concentrate or focus light.

The goal of such manipulation is a variety of applications from optical communications, microscopy, sensing, and other applications of such integral lensed systems or other light concentrating or focusing devices that could not be achieved without the essential steps of this invention. Thus, these waveguide or other structures can act as stand alone elements or be included as part of a complex of components to achieve solutions in microscopy, scanning and in other areas that are not achievable otherwise and these inventions that have resulted from these new and highly accurate optical elements are also part of this patent.

### BACKGROUND OF THE INVENTION

The invention originally was conceived as an outcome of identifying difficulties of attaining a lensed structure at the tip of an optical fiber. Such difficulties are illustrated by the patent history in this area.

Patents as far back as 1986 [e.g., U.S. Pat. No. 4,589,897 to Mathyssek et al.] have attempted to try and address this problem. In the approach of Mathyssek et al U.S. Pat. No. 4,589,897 simple constriction of the core and the cladding was achieved that resulted in a shape that was lens like at the tip of an optical fiber. This constriction was applied at some intermediate point between the two ends of the fiber. The control of the fiber lensing in such an operation was not effective and this process was improved upon by Presby U.S. Pat. No. 4,032,989.

The Presby patent did not employ a constriction process as in Mathyssek et al U.S. Pat. No. 4,589,897 but used an ablative process with a laser at the tip of a fiber. The ablative process of Presby removes material as a fiber is rotated in the ablative laser beam. The process of ablation is emphasized in the patent of Presby by the fact, that as shown by Presby, the laser axis and axis of the fiber make an angle of greater than zero degrees and much less than 90 degrees. Zero degrees is having the laser axis and the fiber axis being parallel to each other and 90 degrees is having the laser and the fiber axis being perpendicular to each other. The patent specifically does not consider the critical geometry that is needed for the melting process which is a head on geometry which is 180 degrees in the geometrical arrangement of Presby or other melting geometries between 90 to 180 degrees. The patent further emphasizes ablation by the claim of the use of excimer lasers which are critical lasers for ablation of glass. In essence the patent is aimed at forming lenses by laser machining that occurs as the tip of a fiber is rotated in a laser beam to form a refractive lens structure that is clearly seen in FIG. 4 of the Presby patent. This lens structure, as will be described below, is far from optimal both in terms of the geometry of the lens and in terms of the fact that the nature of the core is not affected by the procedure. This results in large losses and the inability to make appropriate arbitrary structures that are essential for forming lenses including ultra microlenses to meet all the demands of modern optical communication, sensing and other integral fiber lens applications.

In view of these problems extreme measures were taken in the patent of Shiraishi et al U.S. Pat. No. 5,446,816. These inventors realized that the lack of core and cladding manipulation in the previous inventions of fiber lenses seriously limited the ability to generate the range of arbitrary structures that were needed even in 1995 and this need if anything has become more acute in 2002.

To resolve the problem Shiraishi et al U.S. Pat. No. 5,446,816 used a brute force solution. They formed a surface in an optical material which acted as a lens and then they inserted this into an appropriately constructed sleeve to emulate a core/cladding structure with optical properties that could emulate some of the variety of structures required in a fiber type geometry. It should be noted that the solution of Shiraishi et al is a solution that does not resolve the formation an integral fiber lens with the variations in the lens parameters that are needed today in the variety of applications that lens are used in.

The prior art fails in several directions. First, it was impossible to guide a multi step process of micro or nano optical element formation to achieve the type of elements with the accuracy and repeatability that is required today. The prior art relied on one or another of the processes noted above but has never been able to effectively mesh these technologies to achieve the ultimate micro and nano optical solutions that are desired. In addition, the prior art has not recognized the crucial role of near-field optics together with other scanned probe methods and high resolution refractive index methods in guiding the theoretical simulations for micro and nano optical elements when far-field/paraxial approximations fail. Thus, from both a point of view of guiding the theory and the fabrication and from the point of view of characterizing the resulting elements near-field optics plays a central role in this patent and the prior art has not realized the importance of this technique in such optical element fabrication. Even with such simulations there was no method of characterizing such lens fibers that made measurements in the regimes that the theoretical simulations required.

### SUMMARY OF THE INVENTION

The invention can be summarized as follows:
1. The crucial nature of near-field optics and SPM technology in guiding in an interative way the theoretical simulation and the fabrication without reliance on paraxial/far-field optics
2. The ability to iterate and apply as a result of 1 multiple processing methods that have never been previously integrated
3. The ability as a result of 1 and 2 to produce micro and nano optical elements that could either not be produced previously or could not be produced with the accuracy and the repeatability that can be achieved as a result of this invention.
4. The ability as a result of 1, 2 and 3 to produce new optical devices that were impossible to achieve before the ability to form such micro and nano optical elements.

### BRIEF SUMMARY OF THE FIGURES

The various other objects, features and attendant advantages of the present invention will become more fully appeciated as the same becomes better understood when considered in conjunction with the accompanying drawings, in which like reference numbers designate the same or similar parts throughout the several views.

FIG. 1 illustrates a geometrical model of the tapered fiber lens of a hyperbolic shape described by two paramenters: taper angle (1.4) and the radius of curvature (1.5) at the height of the hyperbola. The units in this figure in the x and y axis are in microns.

FIG. 2 illustrates an emerging wave from the fiber lens as calculated by the simulation. Shown is the intensity distribution of the emerged wave at λ=1.5μ from the tapered fiber lens of hyberpolic shape with the tapered angle −43 degree and raidus of curvature −3.5μ.

FIG. 3 illustrates the coupling efficiency as a function of waist diameter.

FIG. 4 illustrates a comparison of experimental and calculated data for dependence of fiber lens working distance via waist diameter for tapered core fiber lens.

FIG. 5A illustrates the parameters can beadjusted to produce, with high accuracy, protrusions that are important in further steps of integral lens formation.

FIG. 5B illustrates the protrusion of FIG. 5A after a defined etching procedure.

FIG. 5C illustrates the final lens that is produced after laser melting of the structure in FIG. 5B.

FIG. 6 is a collage of the topography (6.1) of the integral fiber lens with the light distribution at the lens surface (6.2) as monitored by the combination of near-field optical microscopy with integrated atomic force microscopy.

FIG. 7 illustrates deep ultraviolet laser stripping that allows fo highly accurate coating of the stripped fiber.

FIG. 8 illustrates a cantilevered lens fiber structure.

FIG. 9 is a represenation of a cylindrical lens as produced by the procedures described by the present invention.

FIG. 10 illustrates a nanindentation as a way to form defined structures on coating that are placed on fibers and other optical components. Dotted horizontal line (10. 1) is placed just above the center of the nanoindenation as a guide.

FIG. 11 illustrates two structures, 11.1 and 11.2, that are solid immersion lens that were fomed by the procedures outlined in this patent.

FIG. 12 illustrates a mushroom lens made by the procedures disclosed by the present invention.

FIG. 13 illustrates a ball lens made by the procedures disclosed by the present invention.

FIG. 14 illustrates a multiple pronged (14.1) structured made by etching and tapering.

FIG. 15 illustrates a nanoparticle grown at the tip of a structure by procedures of this patent that can have the ability to have atomic foce sensitivity.

FIG. 16 illustrates a line-scan of the NSOM image in the focal plan of the multimode lensed fiber.

FIG. 17 illustrates a line-scan of the NSOM image in the focal plan of the single mode lensed fiber.

FIG. 18 illustrates a miniaturized prove fiber-device under test characterization system base on the principles of the characaterization methods described in this patent.

FIG. 19 illustrates a diagrammatic representation of confocal imaging scheme with fibers.

### DESCRIPTION OF THE INVENTION

The present invention describes an Optical Element Fabrication. A new theoretical understanding of the parameters that are important in fiber optical element including fiber lens production is the first inventive step of this patent.

The theory presents a new approach based on an exact numerical field calculation inside and outside the fiber lens guided by constraints that are imposed by near-field optical characterization of the resulting elements. This is a powerful method for fiber lens analysis in terms of coupling efficiency, beam waist diameter and working distance. In this approach the dependence of these important characteristics from the parameters of the fiber lens can be studied. The theory then becomes a tool for designing, for example, an optimal fiber lens. Without this theory and the associated validation of the theory and associated production procedures that are evolved using near-field optical and its associated methodologies for measurements, previous approaches at fiber lens fabrication were incapable of achieving the combination of factors and the tolerances and the repeatability that are necessary for today's optical components. For example, one case, not to exclude all others, is the maximum coupling efficiency of a lensed fiber with active and passive optical devices that have highly defined beam profiles. The combination of theoretical simulation, near-field optics and its associated methodologies and the iterative guiding of the combination for the production techniques allows for high efficiency coupling.

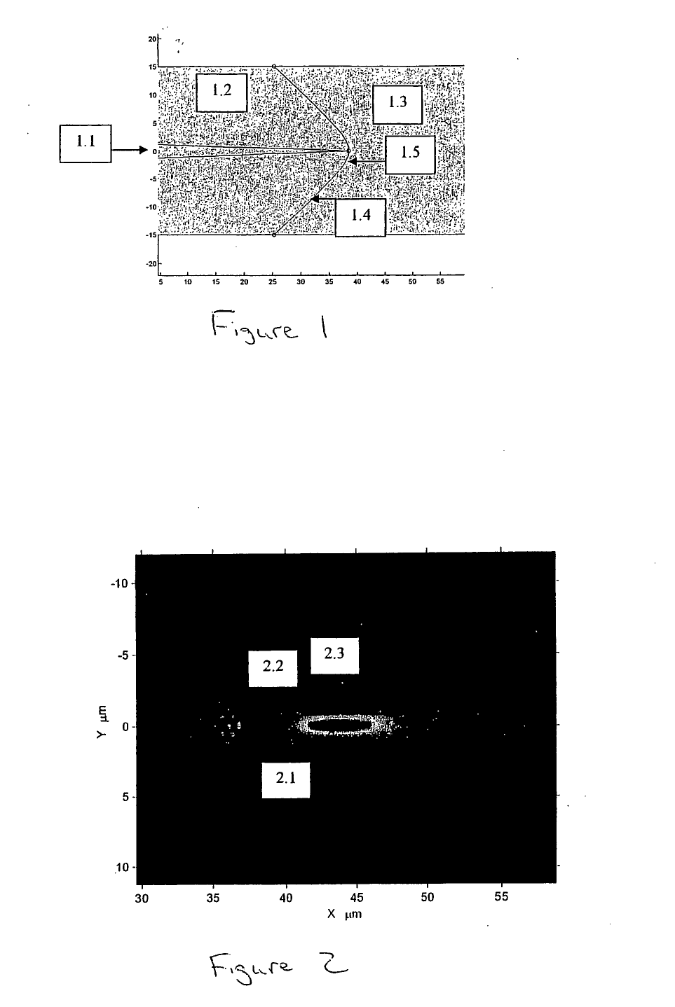

In one emulation of our method not to exclude others we consider a fiber lens with a hyperbolic shape (FIG. 1) which is a geometric result that can be achieved optimally only by a combination of multiple production methods that are a part of this patent. For this geometrical model of the tapered fiber lens, three spatial regions are considered: the core (1.1), the cladding (1.2) and air (1.3). The core has a conical shape with the angle determined by the taper angle (1.4) and the core to cladding diameter ratio. The interface between cladding and air is considered to have a hyperbolic shape. This shape is described by two parameters: the asymptotic angle and the radius of curvature (1.5) at the height of the hyperbola. The asymptotic angle is assumed to be the same as the taper angle (1.4).

We have performed the field calculations utilizing a Finite Element Method for numerical solution of partial differential equations and have realized that this is critical in fiber lens simulations, where the parameters are monitored experimentally with near-field optics and its associated methodologies and adjusted based on the results of the experimental measurement. Both of these aspects of the invention allow for multi procedure production methodologies that is the ultimate goal of this invention.

To realize the criticality of the calculation as the first step in the formation of the optical elements described in this patent we will focus, as an example, on the field inside and outside a fiber lens. This was obtained by numerical solution of the wave (Helmholtz) equation with boundary conditions that were defined and adjusted using an iterative procedure in which the near-field optical measurements and the technologies associated with near-field optical measurements were used to adjust these boundary conditions so that exact replication of simulation and results were obtained. Such iteration and adjustment is novel.

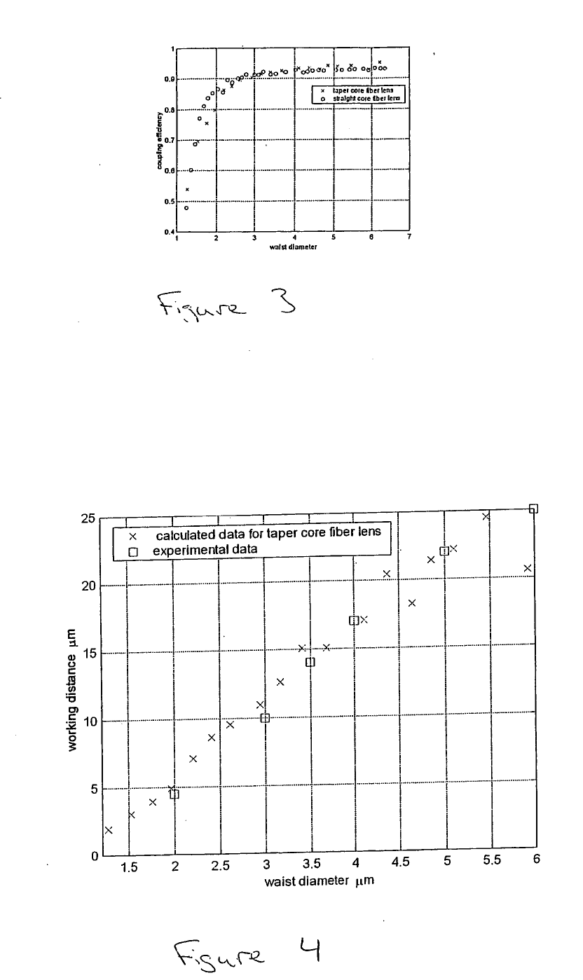

For the field propagating from left to right in FIG. 2 and emerging from the fiber lens, the initial boundary condition on the left boundary inside the fiber was that the value of the field on this boundary coincides with the fundamental solution (HE₁₁ mode) for the single mode fiber. For the field propagating from the right to left and entering into the fiber lens the initial boundary condition on the right boundary, was according to the near-field optical and associated methodologies, was that the field on this boundary has a Gaussian form with the waist diameter equal to the laser spot size.

In FIG. 2 one emulation of the invention is considered which is a wave (λ=1.5μ) emerging from a tapered fiber lens of hyperbolic shape with the taper angle −43 degree and radius of curvature −3.5μ. In this emulation, the emerging wave from the fiber lens is focused 5μ (2.1) away from the end of the fiber (2.2) and has a waist diameter (2.3) that is as small as 2μ. The calculated coupling efficiency for this fiber lens is 80%.

The theory allows us to predict the parameters of the fiber lens that for a given waist diameter will give maximum coupling efficiency (see FIG. 3 for a sample calculation for one emulation of the invention). This was not available previously.

Previous work, that was based on simply tapering the cladding [Edwards C A, Presby H M, Dragone C, Ideal microlenses for laser to fiber coupling, Journal of lightwave technology, 11, 252, 1993], was unable to achieve waist diameters that are less than 3 microns. From the above theoretical results we can now predict that with wavelengths of 1.5μ waist diameters of 1.2μ are achievable and for shorter wavelengths diffraction limited focusing can be achieved.

The theory also predicts that large coupling efficiencies are possible with such coupling efficiencies being over 80% for waist diameters between 2 and 3 microns and over 90% for waist diameters above 3 microns and these values of coupling efficiencies can be achieved without anti-reflection coatings which would add upto 4-5% to these extremely high efficiencies. Such coupling efficiencies are important and the resulting simulations for all lenses are equally important.

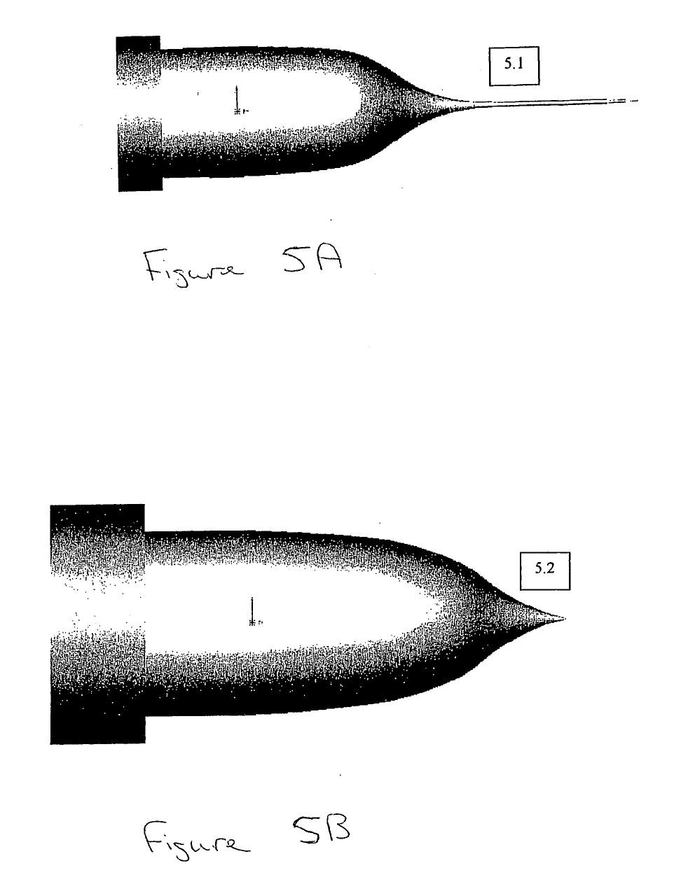

Near-field optical measurements allow us to practically confirm the theoretical predictions and help define the boundary conditions of the calculation. This is shown on the graph in FIG. 4 in which the theoretically predicted waist diameter is confirmed by such near-field optical measurements. Thus, an essential component in the theoretical developments are the hand in hand characterization of the near-field optical measurements associated with specifically designed fiber lens fabrication methods as highlighted in this section. The same is also the case with all such simulations, fabrication and near-field optical characterization of the elements described in this patent that have resulted from this invention.

Thus, in conclusion an inventive step of this patent is that the methodology of theoretical simulations with adjusted boundary conditions iteratively defined by near-field optics and its associated measurement techniques allows for:
1. The availability of exact field calculations as an effective method for design of fiber lenses and other optical elements in which the general far-field optical approximations partially or completely fail.
2. Near field and associated measurement of the field emerged from the fiber lens as the only reliable method for its characterization and the generally used far-field characterization methodologies are not valid for the components described in this patent.

Both of these developments have not been previously applied to fiber lens fabrication and/or the other elements described in this patent. The use of these methods allows for a complex combination of fabrications procedures for producing state of the art fiber lenses and other micro and nano optical elements.

The technology that is invented here allows for a synergistic integrated interaction with what has been considered to be competing technologies in fiber lens formation or have never been used in fiber/waveguide lens formation. These technologies can be listed as without or with tapering using pulling and/or mechanical and/or laser polishing and/or heating, with and/or without etching and/or writing and/or masking with or without imposed radiation and with or without photoresist and/or other similar procedures and/or imprinting depending on the parameters of the micro and or nano optical structure that has to be achieved to produce a coordinated interplay of parameters that have not been achievable till now. In spite of the need to use all or part of these methodologies to the appropriate extent and in an appropriate order to produce the type of micro and nano optical elements that are needed, the difficulty of integrating these diverse technologies into a synergistic whole rested on the inability to accurately characterize the results of the integration both in terms of topography and light distribution in the near-field.

As an introduction to this section, it is realized that, together with what has been described above for theoretical simulation, the application of integrated characterization tool is a critical part of the process which allows for highly accurate geometric and light profiling of the micro and/or nano optical structure at the surface, in the near-field or at specific distances above the micro and/or nano optical structure with little contribution from out-of-focus light so that the phase properties of the wavefront can accurately be characterized in a way that is totally integrated with atomic force topographic and scanned probe methods (SPM) for micro and or nanoscopic characterization including nano and micro heat sensing and/or with light wave measurements such as return loss, polarization dependent loss, coupling efficiency and other similar parameters and that these methods are also totally integrated with far-field optical characterization including high resolution refractive index imaging. This integration of the simulation, production and characterization is a realization that near-field optics within this context of integrated characterization, simulation and production is the critical missing link that facilitates such multistep procedures for micro and nano optical element production.

In terms of the introduction above, it is realized as part of this invention that monitoring light distribution through a near-field optical aperture even in the far-field has unique properties in terms of the information that can be obtained on the lens or optical system that is being investigated. Specifically, a near-field optical aperture is a very small aperture that can be as small as 1/10 the wavelength of light. Such an aperture accepts light from a very wide angle and this means that the light that is collected only at the aperture has enough fluence to be detectable. Thus, the light that is collected by such an aperture is not contaminated by out-of-focus light that is even 1/10 th the wavelength of light away from the aperture. When this is added to the fact that the aperture acts as a coherent point source of collection one can see that monitoring the distribution of light with such a small near-field aperture in the far-field allows for the monitoring of a coherent wavefront. Thus, if such light is monitored at several optical planes around the focus and/or away from the focus of say a lens that is being investigated then one can determine, by interaction with the theoretical simulation above, the phase properties with high accuracy of the optical system being investigated.

It is true that measuring phase properties with a lens has been accomplished using an algorithm which is based on the transport intensity equation [A. Barty, K. A. Nugent, D. Paganin and A. Roberts, Optics Letters 23, 1 (1998)]. For this equation one needs to know the intensity in the object plane for different z sections. Measuring this intensity by means of a near-field optical probe has advantages even over such indirect lens-based methods. Since with a near-field optical probe the information that is collected has none of the distortions that occur when optical data is transformed by the optical system which the case of Barty etal al is a lens. This includes the fact that, as noted above, the near-field optical technique obtains the intensity information not only without lens based distortions but also without any out-of-focus contribution. Therefore, near-field optical methodology of the light distribution in one or more optical planes is a true measure of the intensity at different z sections. In addition with such a methodology one can consider combining the near-field optical information at certain points with the lens based information to obtain rapid analysis of the phase properties at resolutions much better than can be obtained with lens based techniques for refractive index, phase distrbution and other phase based properties. Also such a combination can obtain the information much faster than near-field optical techniques alone.

In addition, it is realized that the combination of near-field integrated with far-field optical characterization and with atomic force imaging and other scanned probe methods (SPM) allows even for standard techniques for phase and refractive index measurement such as differential interference contrast (DIC) to be considerably improved. For example in one emulation not to exclude others, in DIC if there is even a small slope on the sample in the region where the far-field DIC is being measured the DIC image has an artifact due to the slope and the phase and refractive index properties are flawed. The presence of an on line SPM will allow the exact determination of this slope to less than a nanometer and will allow one to free the data from such artifacts.

In another emulation of such a combination, the near-field optical device is used to provide a stable source of light for the point spread function (PSF) of the far-field optical imaging system which can be based on confocal DIC or DIC with CCD imaging. Such knowledge of the PSF is crucial to the high accuracy of the index of refraction that is needed for the full characterization of some of the devices that are part of this patent. In addition, the PSF can be obtained with the device under test in place and this has never been possible previously. The device under test contributes significantly to the PSF and can alter the PSF at different locations in the sample so multiple measurements of the PSF at different locations on the sample may be needed for full theoretical analysis of the results by the theoretical procedures described above. In addition, it is realized that glass-pulling technology or other technologies allow for the production of unique point sources that can add singular information on the optical properties of the far-field microscope especially for DIC. One such structure not to exclude other structures is the ability to produce a near-field optical element with two tapered fibers in order to deliver to the microscope two beams of controlled polarization and known shear vector. This allows for a true DIC PSF and is important for the achieving the highest accuracy in index of refraction measurements. All of this is possible since such glass structures or other silicon processing methods allow for these near-field element based points of light to be present on the optical axis without obstruction from the integral atomic force cantilever that keeps the point of light with extremely high stability relative to the sample being investigated by atomic force feedback.

In addition, it is realized that a DIC measurement can be vastly improved by the controlled positioning with for example an atomic force sensor of a particle that either alters locally and/or nanometrically the DIC image at one position and then at another position. This being completed a defined number of times and the result, together with the exact 3D position from the atomic force sensor, being used as a constraint for the theoretical calculations outlined above to define the optical properties of the device under test including the 3D phase image which is an accurate representation of the refractive index in 3D. It is important to note that with such highly accurate 3D representations of refractive index it is possible to characterize embedded waveguides and waveguides that are not embedded in unique ways. In one emulation, not to exclude other emulations, it is possible to pass a femtosecond laser through a waveguide and effect its index of refraction through, for example, the optical Kerr effect. This change can be measured with these highly accurate methods of 3D refractive index measurements and thus one can watch the electric field and the intensity of the laser propagating in the waveguide. Also it is indicated that methods using SPM techniques of heat sensing can also be used to watch such propagation of radiation as it heats the material in the waveguide or other structure.

In addition to DIC one can also use a conventional far-field imaging system with or without DIC or with and/or without non-linear optical phenomena such as for example second harmonic generation and simply block at certain controlled positions the rays of light reaching a detector in transmission or reflection mode and this information, together with the exact 3D position from the atomic force sensor, can be used as a constraint with the calculations above to deconvolve high resolution image of the device under test. This approach also can be used effectively with difference techniques where the blocking is used together with differences in intensity when the probe is generally transparent but has a nanometric or larger opaque particle at its tip that either blocks or does not block the rays of the far-field imaging system from the position on the sample. This can be done transiently, for example, in intermittent contact or some other similar mode with the data collected at two positions in contact and at some distance from the surface. This will allow for difference spectra to be gererated. Obviously, the data can also be collected at multiple positions of the particle from the surface. These ideas can be extended to any techniques that use far-field optical imaging for example confocal Raman microspectroscopy. In some cases these methodologies can be combined with evanescent wave illumination instead of the conventional illumination that is present in all far-field optical microscopes. In all cases the use of an atomic force sensor directly correlated pixel for pixel with the optical imaging allows a very strict delineation of the surface of the sample and this is a powerful constraint for the theoretical calculations.

In addition, it is also realized that such iterative procedures of simulation, production and characterization can also use the data on refractive index profiles and other high resolution far-field methods as a parameter that can be minimized mathematically to give the best integrated solution with all the test parameters described above. This could be especially important in planar waveguide production with say femtosecond lasers as an on line monitor or refractive index changes both as a constraint for theory and for guiding subsequent fabrication.

In addition, it is realized that near-field optics in reflection or transmission mode is also capable of refractive index information since the reflection or transmission from a device under test illuminated by a near-field optical element can give the index of refraction relative to a known refractive index, eg. Air.

In addition, it is realized that the near-field optical element can be combined with fiber couplers etc to allow mixing of collected light that is illuminating the device under test in order to investigate phase properties also in the manner of a fiber interferometer with one of the arms being a near-field optical device.

Thus, an important aspect of this invention is the realization of the criticality of near-field optics as part of micro and nano fiber or other lens or other optical element production with defined properties and such definition was impossible before this invention.

The integrated procedures of production, that can now be guided by the simulations and characterizations noted above, lead to new horizons in such lens fiber production. One example, not to exclude others, is the fact that, before this invention, for fiber lens production based only on tapering the cladding, the waist diameter was based on the radius of curvature and the tapering angle that is achieved by the polishing or etching. On the other hand, as the simulations and characterization guidance has demonstrated tapering the fiber such that the cladding and the core are tapered and then using etching or polishing to simply alter the cladding and not the core permits an additional degree of freedom. Namely the fiber lens parameters depend now on the taper angle of the core, taper angle of the cladding, which is now independent of the core taper angle and the radius of curvature of the cladding. This allows for many advantages including the reduction of the waist diameter to be less than 3.5 microns, which has not been achieved by any method before this patent. In addition such manipulation allows for large coupling efficiencies to be achieved greater than 80% between an appropriate active waveguide (a laser) and the fiber lens acting as a collector or injecting light into a passive waveguide.

Another result of this invention is that such ultrasmall diameters can be achieved with a control of the focal spot to a diameter of 0.25 microns in the wavelength regime of interest to the telecommunication industry between 1.3 and 1.6 microns. This has also been impossible previously even for larger spot sizes. Nonetheless, to achieve such control is crucial for the type of coupling efficiencies demanded by this industry and without this invention there was no way to know what combination of the above parameters have to be employed in order to achieve these results.

One emulation of this invention (not to exclude other emulations), is when the tapering of the fiber is done under laser heating with defined tension and defined cooling. For achieving the characteristics needed for this goal the heat has to be kept at a minimum while the tension is kept at a maximum with a cooling that has to be optimally controlled based on the results of the near-field optical characterization and its associated methodologies and the iterative theoretical simulations. The pulling gives a specific angle of taper to the fiber tip. The control of this waist diameter to a level of ±0.25 microns depends on the exact characteristics of the taper and this needs to be accurately simulated and characterized together with the waist diameter of the beam and these parameters can be measured by including near-field optics and its associated techniques in this loop of iteration. It was not realized previously that such a closed loop had to be a critical part of the process of lens formation, which had to maintain Gaussian characteristics. In fact before this patent integral lens fiber makers publicly indicated the need to develop characterization tools.

In addition, with such closed loop control we have realized that the spot size is not only related to the cone angle but is also related to the separation between the end of the fiber and the position to which the core extends. With the control that we can now exercise we can modulate the geometry and the nature of the laser-heating phase at the tip after the tapering with tension, heating and cooling discussed above. In one emulation not to exclude others, we have accomplished reproducible coupling efficiencies of >80% for a variety of lens parameters with such fine control.

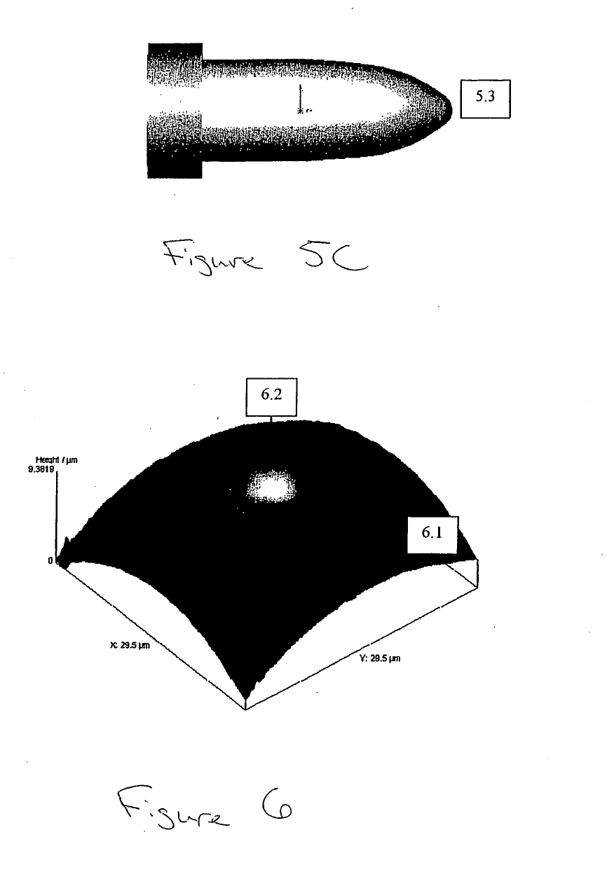

In another emualtion of this invention (FIG. 5A) not to exclude other emulations it was realized that for fiber lens production there was great importance to the protrusion that can be produced as a result of the pulling with tension, heating and cooling discussed above. The defined protrusion in the center of the fiber (5.1) has to be controlled depending on the parameters of the lens as characterized by the techniques discussed above. The protrusion allows us to control the centration and this has never been discovered as a parameter of crucial importance in such fiber lens formation. This protrusion is subsequently removed to defined distances with controlled etching as defined by the characterization. For example 30 minutes is needed to produce a geometry that modulates the curvature (5.2) of the protrusion as seen in FIG. 5B. Subsequent laser or other melting (see FIG. 5C) is used to achieve the final parameters of the lens (5.3) as defined by the near-field optical results.

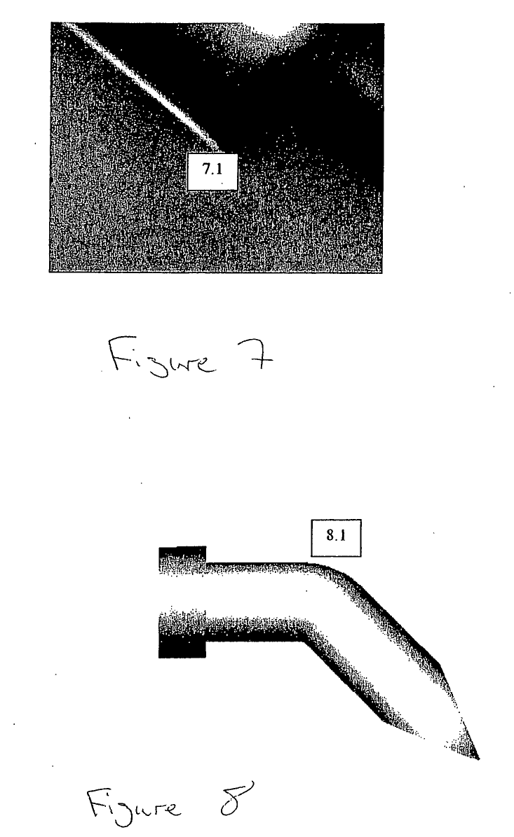

The parameters are recorded electronically and the subsequent detailed characterization of the resulting lens by procedures described above is crucial in setting the parameters (FIG. 6).

Such simultaneous characterization of both the topography and optics is essential to achieve the type of registration between the parameters that permits spot sizes with accuracies of 0.25 microns to be achieved along with accuracies in the working distance of ±1 micron, which is at the very limit of diffraction. In addition, there is excellent centration of the resulting lens.

In addition, the technology allows for lensing with high accuracy of the lens position to the point of the fiber that can be stripped with extreme accuracy of a few tenths of a micron (7.1) using laser ablation of the stripped fiber with deep ultraviolet lasers FIG. 7.

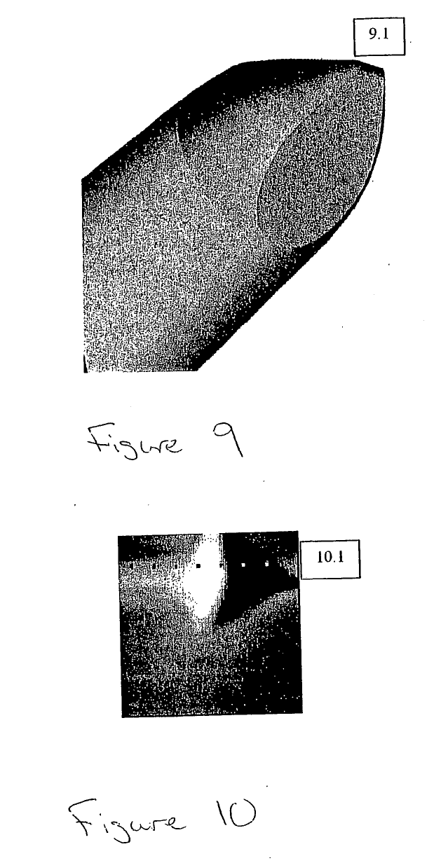

Cantilevering (8.1) the fiber can be achieved to direct the light at an angle relative to the direction of the main length of fiber (FIG. 8). One set of parameters not to exclude others is fiber bending at angles that can be varied from 90° to 0° (i.e. no bending).

In addition, it is possible to use a combination of the techniques described above to achieve tapering with polishing and lensing at ninety degrees to the fiber axis or with appropriate coating to produce a beam splitter by coating a mechanical and laser polished lens on one face only or producing an elliptical structure on one side of a polished lens

Using the above procedures a variety of shapes and combinations can be achieved with the control that is described above.

It is worth describing another emulation of this invention, the formation of a cylindrical lens (9.1) (see FIG. 9), in which the interfacing of the technologies of the tapering with tension, heating and cooling discussed above combined with laser and mechanical polishing guided by the simulation and characterization described above.

In this case the lens made by the above procedure is subsequently polished from two sides (180°) from one another and then another laser step is introduced to smooth the rough polished surface to achieve the control and optical quality that is desired. With such a combined procedure it is possible to achieve a ratio of the elliptical axes of at least 1:3. This is another emulation of these combinations but does not exclude other combinations.

The combination also permits the achievement of optical phenomena in which not only can lenses be made with preservation of the polarization of a polarization preserving fiber but also conditions in which polarization can be achieved through a lens without the use of polarization preserving fibers.

Also the deposition of metals on the stripped fiber for soldering and other requirements including magnetic attraction can be achieved with high accuracy relative to such fiber lenses both in terms of vacuum deposition and electrochemical and electroless depositions if the criticality of the characterization described above is applied in a closed loop to such fiber lens metallization. These depositions can be used to achieve hermetic seals to various packaging by combination with electrochemical deposition and the galvana plastic deposition of materials such that the material is deposited in a plastic form. They can also be used to achieve 3D depositions of the fiber by soft lithography techniques or controlled vacuum techniques with rotation together with the lensing procedures invented in this patent. The resulting structures can also be laser welded.

All of the procedures described in this patent can also be used to other waveguide structures including those that can be microfabricated with silicon by the alteration in the refractive index of silicon by doping or other means.

These metal depositions can completely cover the lensed or the unlensed fiber tip or waveguides made of other materials as described below. Apertures can be formed on this structure by one of several means that are part of this invention.

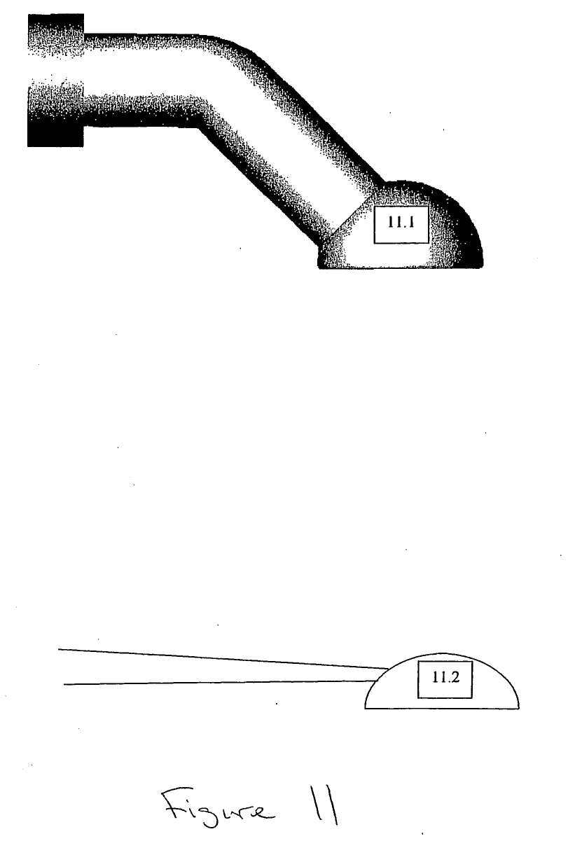

First, the process of nanoindentation (FIG. 10) can be used to create a nanodimension opening (10.1) at the tip of the structure of the fiber or the side of a fiber that is polished at an angle at the end or at any point that is desired. In one emulation of this procedure the resulting structures can be controlled in terms of their optical output in an iterative way if the structure of the fiber aperture achieved is complexed with the light input and output both in terms of intensity and/or distribution. This will permit automation of such aperture formation using either nanoindentation procedures or other procedures that could produce nano openings and these include focused ion beam, chemical etching etc. Also a femtosecond laser can be used to produce a nanodimension opening using non-linear ablation. Also a process of laser or heat assisted nanoindentation is possible in which a device makes the nanoimpression and a laser or other device is used to transiently metlt the surface in which the indentation is to be created. Also, the metal depositions can completely cover the lensed or the unlensed fiber tip or waveguides so that an aperture or apertures can be formed on these structures by coating the device fully with metal and then dipping the fiber tip in a solution that will deposit a resin or other viscous solution on the surface such that at the lens because of its angles and interactions is not coated with the viscous solution and so a small region of the metal coating can be exposed and etched allowing for the coating to be in close proximity to the lens preventing subsequent problems such as vibrations and other mechanical or similar problems.

Obviously in all such procedures the characterization procedures described above are crucial and without this characterization the parameters of the procedure used could not be effectively adjusted.

The approach described in the above in which accurate simulations are combined with unique integrated characterization are also critical to the fabrication of these and other components that can achieve lensing and/or waveguiding including mode convertors, multi lens arrays and other solutions such as microelecromechanical approaches and silicon waveguides in which dopants are used to create waveguides in silicon substrates or femtosecond lasers are used to alter index of refraction in a variety of materials. All these lensing or waveguiding solutions will not be able to achieve their desired results without the integration of the simulations and the characterization that are part of this invention. Only with such simulation and characterization can accurate parameters be defined and no previous invention has realized the criticality of such a closed loop of theoretical simulation, characterization methodologies and diverse production technologies including materials that require standard microelectronic and microelectromechanical fabrication in order to produce defined lensing and/or waveguiding structures that are in glass and/or other materials with a variety of geometries including materials that require standard microelectronic and microelectromechanical fabrication.

In addition to the above, the invention, with its ability to combine simulation with fabrication and highly accurate characterization, also allows the integration of near-field optical photoalteration and/or atomic force microscopic lithography as a tool to add Fresnel and diffractive optical capabilities to the tip of a fiber either tapered, polished, untapered, previously lensed or unlensed.

The method that we have discovered is that the fiber can be moved relative to a near-field optical tip through which a laser such as deep UV laser is passed. This permits the formation of an altered index of refraction at the tip of the appropriate fiber with a resolution that is sufficient to form a Fresnel lens or the formation of a pattern to form a diffractive optical surface. A deep UV fiber with a lens produced by this procedure or chemical etching or atomic force lithography or focused ion beam or any other method or combination of these methods that can change the refractive index and or the topography of the core of the fiber with sufficient resolution can be used to produce such a Fresnel or diffractive lens.

Again, the theoretical simulation and near-field characterization described above is critical in this fabrication process.

In addition to the above the techniques of deep UV lithography, with and without projection techniques, as used in the semiconductor industry and these can be used to form a pattern onto the fiber tip that can alter the index of refraction or topography in a parallel fashion. This aspect of the invention can not only provide for focusing but can also provide for dispersion compensation and multifocal and other characteristics such as phase front correction, removal or imposition of birefringence or removal of various aberrations in the resulting lenses.

Again the iterative simulation and characterization tools described in this patent are essential for achieving these parameters.

These lenses can be inserted into laser and mechanically polished tips in order to combine lenses with the beam splitters described above or other optical components at the tip of a fiber.

The above procedures allow for any optical parameter that is allowed by Fresnel or diffraction theory or other theories to be achieved. An example is a cylindrical lens with two axes having the same foci. Also as noted above the invention is also not limited to uv laser radiation and other lasers can also be used such as ultrafast laser ablation and and/or index of refraction alteration by linear and multiphoton processes. Furthermore, as noted above laser or other methods of heat or other assisted and/or unassisted nanoindentation can be used to reproduce diffractive or Fresnel structures by such assisted nanoimpressions.

With the guiding of the simulation and characterization that is a crucial component in this invention such diffractive optical elements can be combined with nanoapertures and a variety of materials to obtain unique characteristics of guiding of light. An example is the formation at the end of a fiber for example of a diffractive optical structure in silver or gold or aluminum with an appropriate coating of a dielectric and an aperture appropriately placed. This could allow for the manipulation of the light by an interplay between the aperture light transmission and the plasmon characteristics of the metal for obtaining unique light manipulation. The dielectric material and the metal thickness and the number of layers can be modulated in order to achieve a match with the wavelength that needs to be manipulated. Such manipulation can range from no dielectric and only one layer of metal to different numbers of dielectric and metal layers with a variety of thicknesses depending on what characteristics are desired. All of this is guided by simulation and the near-field optical and SPM measurements that are the crucial component in this patent.

All of these unique lenses can be combined, as with all the lenses above, with and without Bragg gratings written into the fiber in the path of the fiber before the lens. The variety of procedures that the simulation and characterization of this invention allow permit the selection and order of the methodologies in order to lens a fiber Bragg grating without erasing the grating.

In addition, the Fresnel or diffractive optical element can be produced on another fiber, which is spliced to the fiber in question.

In addition the processes described above can produce a solid immersion lens with high index fibers. In such a procedure before or after-tapering a ball can be formed at the end of the fiber by laser melting and the ball can be subsequently polished by a combination of mechanical and laser polishing to produce a flat mushroom head that can act as a solid immersion lens. The ability to combine mechanical and laser polishing is crucial here since the surface of the polished surface has to be made optically of good quality with laser polishing. Once again an essential component is for the solid immersion lens to be simulated and characterized by the characterization tools described above without which the characteristics of the lens cannot be effectively achieved.

In one emulation such a lens (11.1) can also be placed at the end of a cantilevered fiber (FIG. 11) to provide the additional sensitivity of an integral atomic force sensor so that the solid immersion lens can be brought in contact or can closely approach a surface and also to sensitively align this lens relative to the illuminating microscope objective. In another emulation, not to exclude other emulations, such solid immersion lenses can be made with various polishing combinations, as described in this patent, so that it could have other geometries such that the flat surface can be polished to a tip and coatings can be applied if so desired. These lenses can also be combined with Fresnel and diffractive lens characteristics.

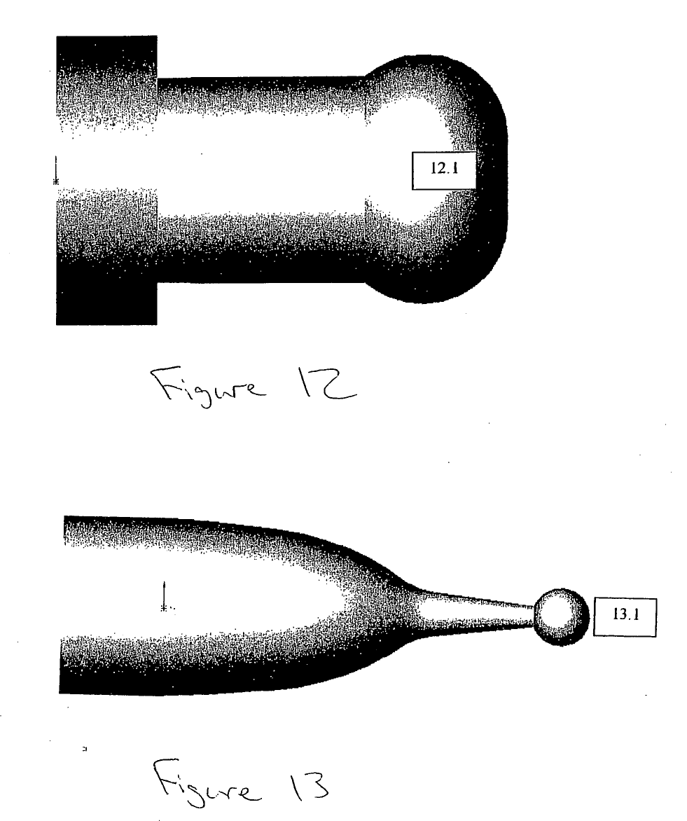

Other unique structures such as mushroom or ball lenses can be achieved with tapering and lensing with fibers and hollow tapered micropipettes and fibers where the subsequent heating with a laser can be used to form a mushroom (12.1) (see FIG. 12) or ball lens (13.1) that can be used as a collimator with a handle (see FIG. 13). Such a ball lens can be used to provide combinations unachievable by other methods such as large fibers that have tapers to concentrate light combined with lenses. Simulation and characterization can produce controlled divergence and subsequent ball lenses as described here can produce collimation. An example of one application of this aspect of the invention is the need to concentrate large light sources into collimated light sources to enter devices such as fibers with smaller diameters.

In addition, the methods described in this patent in which the essential components of simulation and near-field and associated characterization are used to guide the fabrication as described above, can produce a lensed fiber in which the spot size at the focus is the same as the core diameter at a distance of upto 50 microns.

Such ball lenses can be used as one such lens or multiple such lenses. For example in one emulation, not to exclude others, an integral fiber lens can be integrated with a ball lens to get a collimated beam of light that can then be used with a second ball lens or regular lens to get a very small diffraction limited spot size. Such combinations can also allow for a working distance of an integral fiber lens to be extended. For such extension of the working distance from the fiber lens it is possible to get small spot sizes far away by, in one emulation not to exclude others, to have an integral fiber lens, one ball lens for creating a parallel beam and then another ball lens with an aperture to obtain the highest resolution at the longest distance away from this second ball lens.

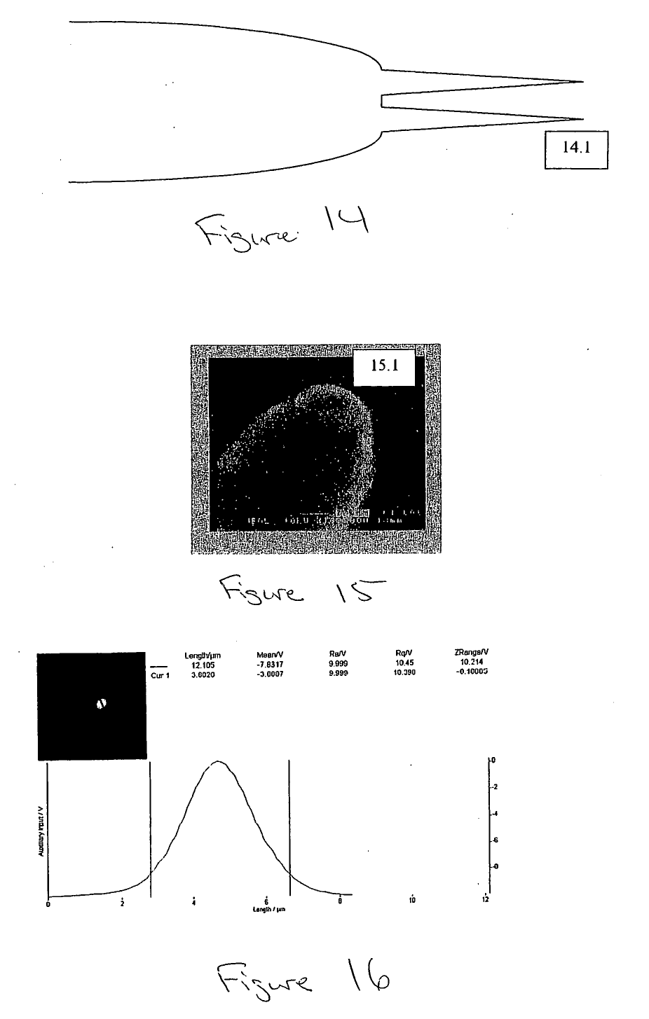

In addition, the procedures described in this patent that include tapering and etching allow for structures in polarization maintaining fibers that permit for multiple pronged structures (see FIG. 14) which can be used either uncoated or metal coated. In the case where coating is placed on these structures the structures can be used as electrical tweezers so long as the coating is produced on each of the multiple pronged structures in a way that the isolation between the metal coated structures is preserved.

Tapered micropipettes with and without cantilevers can also be used for very controlled light concentration beyond the diffraction limit. For achieving such concentration, in one emulation, a silver nitrate solution can be introduced into the appropriately tapered pipette and the pipette is inserted into a sugar solution for controlled lengths of time to form a nano seed of silver (14.1) (see FIG. 14). This nanoseed can then be grown by electroless methods into a controlled nanoparticle of gold or silver or aluminum or a variety of metals that have plasmon resonances that can be used to concentrate light.

The above procedure is only one emulation. Other emulations include putting the sugar in the pipette and the silver nitrate outside. Controlled pulling of the pipette out of the surrounding liquid to produce rod geometries at the tip of the pipette has also been discovered and the use of other combinations to deposit other metals at the tip are other emulations of this invention. Also other solutions-that permit the formation of these and other metallic particles at the tip of such tapered micropipette or other structures are also part of this invention.

In addition, other emulations include various combinations of illumination, heat etc during nanoparticle formation at the tip of these structures and these can alter the characteristics of the particle and is also an important part of the invention.

The structure allows for the insertion of liquid in the hollow pipette structure to act as a cooling agent for the nanoparticle during illumination.

Finally, such hollow tapered pipettes or other such devices in materials, that are not glass and that are cantilevered or not cantilevered, can be used to produce apertured waveguides by molding. In such an emulation, a tapered micropipette or other similar hollow device is coated with a metal or an opaque substance for the optical radiation that is being used. The hollow cavity is then filled with a liquid that will form into the shape of the hollow region. This liquid can be a melt or a solution that will turn into a plastic or any other material that will have similar qualities, i.e. a liquid that will harden into the structure of the hollow region. If the material that will harden will have after hardening a larger index of refraction it will act as a waveguide and the light will be confined by the opaque material surrounding the tapered pipette or hollow cavity. Obviously the simulation and the near-field optical and other characterization techniques are crucial in defining the structure, the refractive index and the light modulating properties of such devices.

Similarly, tapered or untapered pipettes or other hollow devices could be filled with such hardening materials and with controlled pressure and controlled wetting the extent that the liquid will exit the opening can be controlled. If the exit of the hollow device filled with the liquid is then placed on a mold the exiting liquid will fill the mold and harden to form an optical element. Obviously, multiple such hollow tubes and multiple such molds can be used to automate making multiple device and/or to make multiple device arrays. Obviously, the essential characterization component of this patent can be used to characterize micro and nano lens arrays which are made with or without molds or with or without hollow tubes to make an individual micro or nano optical device or arrays of such devices and these characterization techniques are crucial for making such devices that were difficult or unable to achieve with the accuracy that is needed in today's industry.

In another emulation, the amount of liquid exiting can be controlled to the extent of nanometric dimensions and then coated with metal, to make in one emulation, at the tip of say a force sensing device a nanometric dielectric ball covered by a metallic coating to adjust the plasmon resonance to the wavelength of the laser being employed.

Obviously, a variety of materials can be used including such materials as chalcogenides, not to exclude others, that have high non-linearity or some other property. Such structures could be modulated with electric fields to be used as switches. Also combinations can be achieved such that inverse and/or disposable and/or transparent and/or selectively filled molds are used in order to make structured waveguides with photonic band gaps in such hollow cavities.

The nature of these elements can be simulated by the theory and characterized with near-field optics which is crucial in all these areas.

This will be a very rapid way to produce the elements described that is easily automated. Obviously the size of the hollow opening could be adjusted to match the dimension of, for example, fibers in the network for easy splicing.

In all of the above plastic claddings around the fiber elements can be effectively removed with very high resolution using deep uv radiation lasers. This provides for high aspect ratio removal of the plastic coating of fibers for metal deposition (see FIG. 7, 7.1). The nature of the stripping can also be characterized with the characterization techniques described above.

The number of modes that a multimode fiber can support depends on its numerical aperture (NA), on the wavelength of light (λ) and on its core radius (r). The smaller the core radius, the less the number of modes that the multimode fiber can support. If the core radius is less than some critical value then only a single mode can be supported by the fiber.

In the tapered multimode fiber the core radius gradually changes from large to small. When the core radius in such a fiber becomes smaller than the above-mentioned critical value, only a single mode can propagate in the fiber.

The interesting question here is what happens with the rest of the modes in the tapered multimode fiber. One can think that the higher modes will reflects back in the tapered region of the fiber or its energy will diffuse to the cladding region.

Part of this invention are parameters of the tapered multimode fiber (tapered angle and radius of curvature at the end of the fiber) under which the multimode fiber acts as a transmitter or coupler from the multimode to the single mode regime with as high a coupling efficiency as 50 percent or higher. In such a device higher modes inside the multimode region of the fiber gradually transform into a single mode as the end of the tapered fiber is approached.

To demonstrate this effect, in one emulation, we have taken a multimode FMSD fiber with a core diameter 50 um and NA 0.2. It was tapered by a pulling procedure with laser melting at the end of the fiber. The core diameter at the end of the fiber was about 4 um. Laser light (λ=1.5 um) was coupled into the fiber. In order to determine the waist diameter of the lensed fiber in the focal plane a near-field optical image has been obtained. In FIG. 15 the results of the measurements are shown. The focus was reached at a distance of 12 microns from the surface. The waist diameter of 3.8 microns was obtained.

The maximum coupling efficiency between two optical devices can be reached when they have the same NA's and waist diameters. We have simulated the production techniques that allow for this to be achieved and have characterized the result without our characterization techniques in order to go through the iterative loop to match the mode field diameters in this coupling between the two fibers.

Therefore, the single mode lensed fiber with waist diameter 3.8 microns and working distance 15 microns in the focal plane has been used in this emulation of the invention but other values can also be used that fit the fundamental aspects of this invention.

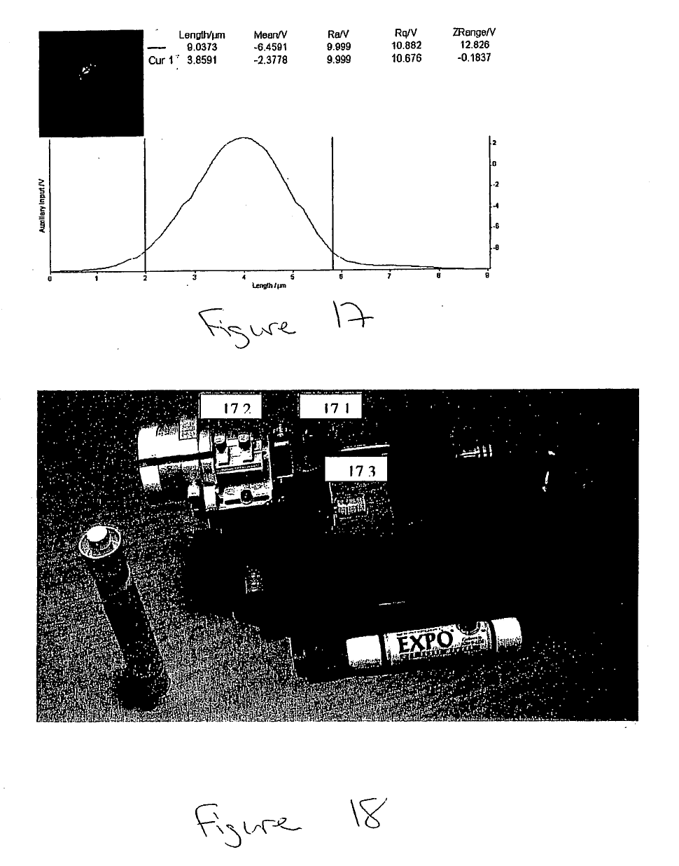

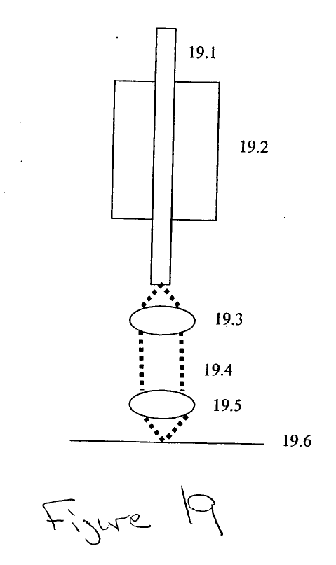

The waist and mode field diameter and working distance of the single mode lensed fiber were also determined using near-field optical techniques. The results of the measurements are shown in the FIG. 16.

The coupling efficiency between multimode lensed fiber and single mode lensed fiber was measured using laser light of 1.5 um. The coupling efficiency 64% has been obtained.

For the characterization described above a near-field optical system completely integrated with far-field optical characterization and with atomic force imaging and other scanned probe methods (SPM) can be used. Often however simpler devices for this particular application are required. As part of this invention we describe a simple device that allows for active feedback to keep the device under test and the probe fiber in highly stable contact without pigtailing. One emulation of the device consists of a probe holder 17.1 and a device under test holder 17.2 that is composed of structures that permit atomic force sensing between the probe and the device under test. For such testing the probe fiber can be glued to a tuning fork for feedback or can be illuminated with a probe laser beam. In both cases the probe fiber sits in a piezoelectric device, 17.3, and is modulated a few Angstroms relative to the face of the device under test. The piezo device as shown in 17.3 can be a cylindrical piezo device that has x, y and z motion. As the probe fiber approaches the device under test the frequency and amplitude of the modulation changes and this is monitored by either the tuning fork or the probe laser.

A preferred embodiment of this invention is that the probe fiber is not glued to the tuning fork but rather the tuning fork and the probe fiber are both held in piezoelectric devices that can bring the probe fiber and the tuning in close proximity to one another until the tuning senses the probe fiber. Then as the probe fiber is under test. When it gets in close proximity to the device under the test the tuning responds to the change and the feedback loop is engaged to keep the probe fiber with greater stability (upto 0.002 dB) relative to the device under test. Under this condition, near-field optical profiling, light wave measurements for return loss etc (which, as part of this invention, are also very important for monitoring the nature of the optical surfaces produced in the optical elements that are generated and other parameters both near and far-field including topography can be measured without pigtailing. In essence the invention has demonstrated that the atomic force sensing acts as an electronic glue to keep the device and the probe steady with respect to one another. The device allows for stability, repeatability and reproducibility with upto 0.002 dB. The device also allows for on-line viewing of the probe and device under test with an optical imaging system (not shown in FIG. 17).

Also in another emulation, not exclude other emulations the device that measures the position of the probe fiber can be a lensed fiber itself as described in this patent or two lensed fibers as can be produced by pulling fibers in a two channel micropipette by the procedures in this patent. With either one lensed fiber or with two lensed fibers or with two or one fiber without lenses the probe fiber position can be accurately measured as it approaches a surface. This is accomplished by sending light through these devices onto the probe fiber and then measuring the reflected or the transmitted light so that as the probe fiber frequency, amplitude and/or position changes as it approaches the sample. The probe fiber and the detecting and illuminating fiber can be either glued together at the appropriate position or held with piezo devices at a defined position.

The essential invention in this and other devices is the realization that today the worlds of nanopositioning, light wave measurements and imaging are separate worlds and this invention integrates and brings these worlds together. Also as part of this invention is the realization that these devices that affect such an integration allow for on line tests and measurements of the type described in this patent as an important part of the manufacturing process in which one device is connected to another device with appropriate means. In this vein it is important to realize that other emulations will allow for three column devices in which one device and two fibers could be handled in one system.

All of the procedures described above are easily amenable to automatic fabrication. This invention includes a complete automated system that includes each of the steps or combinations of steps from the theory of simulation of fiber lenses that is included in a program of a computer controlling the automated process to characterization as described in this patent and complex fiber handling including pick-up etc, tapering under tension and heat, etching, controlled lensing of protrusions, mechanical polishing, laser scribing, etc including all the steps described in this patent.

These procedures can also include the components of this invention that include laser and other methods of index of refraction alteration and other procedures described in this patent.

However, the critical components in the process are the simulation and characterization methodologies described in this patent. These allow in an interative fashion the production of the optical elements described in this patent in an automatic fashion. They work even more efficiently in an automated machine based on these principles since the iteration reaches its ultimate efficiency. In addition an automatic machine also blends very effectively with making multiple lenses on a fiber bundle.

One of the results of the optical elements that can be achieved by the inventions of this patent are extremely small spot size lenses that are integral with optical fibers. As noted above diffraction limited spot sizes can be achieved. This means that in the visible region of the spectrum this can be as small as 0.5 microns. In addition as noted in section 5.2.A.1.c these structures can be cantilevered. This means that theyP could fit neatly under the lens of a microscope. With such a lensed fiber or straight lensed fiber that can now be made by the simulation and characterization techniques, that are part of the inventive step of this patent, we have invented a simple scanning integral lensed fiber based confocal (SILC) microscope. This uses the same piezo technology that was described in section 5.12. Such a device would readily replace complicated beam scanning confocal microscopes with much higher throughput, collection efficiency and resolution than conventional confocal beam scanners. The latter arises from the fact that the integral fiber lens is scanned. This means that all aberrations except spherical aberration is eliminated. Usually only sample scanning can achieve such resolution. In addition lens fiber bundles could increase the scanning speed by orders of magnitude. This would be similar to Nipkow disc scanning without the problems o the Nipkow disc. The optical path in such a SLIC microscope would be that the light would be passed through the fiber and collected by the same fiber and then put either through a fiber splitter or a dichroic filter. This would also include returning fluorescent light. The lensed fiber could be cantilevered if it is to be slipped under the lens of an upright microscope or it can be placed on an inverted microscope or placed opposite from the lens of an upright microscope.

An alternate emulation would be to place a fiber (19.1) with or without a lens in a piezo tube scanner or other device capable of scanning a fiber (19.2) for scanning and this combination is placed in a port of a microscope or similar device. The tube lens of a microscope or a ball lens (19.3) as described in section 5.7 would make a parallel beam (19.4) and then the objective lens of a microscope or another ball lens (19.5) will create a spot on the sample (19.6).

In one emulation, the piezo tube scanner could scan the beam and the lens of the microscope can cause a focused spot. Such a combination could form a diffraction limited spot on the sample and the lens could collect the light with high efficiency and send it back through the fiber through which the illumination was accomplished. A fiber splitter could separate the excitation and the detection. In addition, the channels of illumination and detection could also be separate. With the illumination through the fiber and the detection through another channel which can be attached to another optical path in the microscope which can have a large area detector including a charge coupled device for detection. In the case of the detector being a charge coupled device the scan of the fiber can be adjusted to fall on a different pixel of the charge coupled device and the software for reading the charge coupled device is adjusted to register the fiber position with the pixel of the device or some other software or hardware arrangement that permits knowing the pixel being illuminated. Also multiple fibers can be scanned also to get more parallel illumination.

Such a system that creates a diffraction limited spot is important not only for the highest resolution and/or super-resolution beam scanning confocal microscopy with the highest throughput but, also in terms of the invention described in 5.2.A.1b, of blocking the radiation with an opaque particle such high resolution confocal imaging is essential. In this later case it is better to scan the sample while keeping the fiber illuminator here fixed. Alternately, one can scan the particle in concert with the fiber beam scanner described in this section. Thus, the combination of these two inventions of very high resolution, very high througput confocal with radiation blocking for imaging allows for new instrumentation and new resolution barriers to be crossed in optical imaging. Obviously, the blocking by a particle can be done in intermittent contact mode so that data can be collected at different positions of the probe to the surface and difference images can be generated from the collected data. It is also possible that the particle can be scanned in unison with the fiber. It is also possible to use multiple fibers and multiple or particles. Also in another emulation the particle can be a particle that enhances rather than obscures the signal and this would occur if the particle had a plasmon resonance at the frequency of illumination.

Obviously the devices described in this section in all emulations could also be used for mulitphoton microscopy. In all cases in this approach the lens sample distance can be adjusted to view different optical planes.

The technique described in this section can be very effectively applied to data storage applications including magnetic storage in read only or read and write systems with and without the use of opaque or enhancing particles. In one emulation of magnetic optical storage writing of bits can be modulated with a nanometrically controlled opaque particle that can be raised from the surface for heating directly with the illumination or illuminated with higher intensity while the particle is on the surface to transfer heat to the surface for writing. The position of the particle can be modulated either by varying the speed in flying head technology or some other active or passive feedback technique with the particle position adjusted either for writing or for high resolution reading. Also other emulations can be conceived with the particle being an enhancing particle with a plasmon resonance at the frequency of illumination.

The high resolution provided by lensed fibers based on the inventive steps of this patent also has implications for other light scanning devices such as scanners for printers, copiers etc. For such applications the invention considers also lensed fiber bundles that could also be of use in such light scanning devices.

The developments in this patent of integral lensed fibers with and without cantilevers and the diffraction limited performance that these lenses can achieve can give very high resolution spot sizes with these spot sizes being even smaller at shorter wavelengths. In addition, these micro lenses are not only have inherent minimal aberration because of their size but also are produced with such high quality because of the simulation, the characterization and the multi step methodologies that are a critical part of this patent. In addition, these geometries of cantilevered fibers with such high quality integral lenses form very good elements for presently available flying head technology in data storage devices. Thus, passive feedback can raise the integral lens fiber that can be made with a short focal distance. Obviously, as described in this patent, a fiber based solid immersion lens can be made with the very light properties of a fiber and again this could be complexed to flying head technology of data storage which could keep the solid immersion lens in the near-field.

The devices described in this patent can also be coated with multiple layers of metal isolated with layers of a dielectric such as silicon dioxide with contacts of the metal layers at the lens of the device. Such devices can act also as optical and thermal sensing devices and such devices can be made with force constants that will allow either in their cantilevered or straight form for the devices to act as atomic force sensors for measuring topography and other scanned probe microscopy parameters such as electrical properties.

This is only one emulation of such multiple coated devices. Other emulations, not to exclude still other emulations, include such probes which are tapered and coated but do not have lenses.

In addition, there are other cases where such multiple coatings can produce at the tip of such optical fiber and other similar elements, light detecting and producing structures. In addition, other devices not to exclude other emulations can include a tapered or other device with multiple metal and separating dielectric coatings so that as the device, which is flexible, bends and the resistance of the material between the metal coatings will change. Such devices have the potential to approach surfaces with feedback based on the alterations in the resistance or other electrical parameter and can also act as a thermal resistor and also could have optical properties as noted above.

Simply stated there has been no similar approach suggested for micro and nano optical element formation where it was realized that a crucial connecting technology was near-field optics that allowed the fabrication of a wide variety of elements that are required in industry today. Applications encompass all areas of optics.

1-78. (canceled)

79. A method for producing a micro, submicro and/or nanostructure for modulating light, comprising the steps of:
providing a theoretical simulation of light modulating parameters for the structure, the simulation being based on an exact numerical calculation of fields within the structure and outside a light emitting surface of the structure;
characterizing the emitting surface of the structure by geometric and light profiling at the surface, in the near-field of the surface, and at far-field distances from the surface; and
predicting and fabricating the emitting surface integrally with said simulation and characterization steps.

80. The method of claim 79, wherein fabricating said structure includes forming an emitting surface on the end of an optical fiber, hollow fiber, or other waveguide.

81. The method of claim 79, wherein providing a simulation includes analyzing coupling efficiency, beam waist diameter and working distance taper angle for light emitted from said structure, and determining radius of curvature for said emitting surface for designing an optimal structure.

82. The method of claim 79, wherein providing a theoretical simulation includes finite element field calculations and/or exact calculations with or without interactively defined boundary conditions, and wherein characterizing the emitting surface includes monitoring the fabrication of the nanostructure using near-field and far-field optical characterization with scanned probe imaging.

83. A method of characterizing a micro, submicro and/or nanostructure in which having a waveguide and/or emitting surface including determining the phase properties of light within the structure or of light emitted from the emitting surface wherein such phase properties are assessed by far-field or near-field techniques including scanned probe microscopic techniques integrated with standard far-field techniques or used without such techniques to determine the phase properties of the structure with or without on-line irradiation or local heat.

84. The method of claim 83, wherein characterizing the emitting surface further includes measuring light emitted from the surface for return loss,

85. The method of claim 79, wherein the step of fabricating includes pulling an optical fiber to produce an axial protrusion at the end of the fiber, and controlling the shape of the protrusion by iterative characterization of the protrusion and comparison with the theoretical simulation of the protrusion structure to form a lens.

86. The method of claim 85, wherein the fiber is fabricated to direct light exiting the fiber at an angle relative to the direction of the fiber axis.

87. The method of claim 85, wherein fabricating includes forming a cylindrical or elliptical lens.

88. The method of claim 85, further including stripping the fiber and thereafter selectively coating the fiber and/or lens.

89. The method of claim 88, wherein coating includes deposition of metal on said fiber and said lens, and further including forming an aperture in the metal coating on said lens.

90. The method of claim 89, wherein forming an aperture includes nanoindentation, ion beam etching, chemical etching, or femtosecond laser nonlinear ablation, or a combination thereof.

91. A method for fabricating a micro, submicro and/or nanostructure for modulating light, comprising the steps of:
forming a waveguide incorporating an emitting surface, and
forming on said emitting surface Fresnel and/or diffractive optics and/or a Bragg grating.

92. The method of claim 79, wherein the step of fabricating includes forming a waveguide having a core and having an emitting surface, and further including forming a diffraction pattern on the core to alter the index of refraction or topography of the core to focus emitted light, to compensate for light dispersion, to produce phase front correction in emitted light, to remove or impose birefringence, or to remove lens aberrations.

93. The method of claim 92, wherein forming a diffraction pattern includes:
coating an end of said waveguide core with metal and dialectric layers; forming an aperture in said layers;
directing light through said aperture; and
manipulating the light, the thickness and number of metal and dialectric layers being matched to the wavelength of light to be manipulated.

94. The method of claim 79, wherein the step of fabricating includes forming a solid immersion lens on a high index optical fiber.

95. The method of claim 94, wherein the step of forming a solid immersion lens includes:
forming a ball on the end of a cylindrical or other structure; and
polishing the ball to produce a flat head that serves as the lens, wherein the cylindrical or other structure could be used as a force sensing device to control the position of the solid immersion lens.

96. The method of claim 95, wherein forming said lens further includes providing diffractive optics on the lens.

97. A method of characterizing optical and other surfaces in a sample imaging system in which nanometric blocking or shadowing is used together with differences in intensity when the nanometric blocking probe either blocks or does not block rays of a far-field imaging system from the position on the sample to improve resolution.

98. A method for light control at the tip of a cylindrical or other structure, comprising:
forming a tapered hollow micropipette;
introducing a solution into the micropipette;
forming a metal nanoseed in said solution; and
growing the seed to produce a nanoparticle in the micropipette for controlling light passing through the micropipette.

99. The method of claim 98, wherein forming a nanoseed includes inserting an end of the micropipette into a liquid for initiating seed formation.

100. The method of claim 99, further including pulling the micropipette out of the liquid at a rate controlled to produce a selected nanoparticle geometry at the end of the micropipette.

101. A method for forming an optical or mechanical structure, comprising:
dipping a tip of the structure in a fluid medium; and
retracting the structure witn nanometric control from the medium to form an optical or mechanical structure.

102. A method for forming an optical or mechanical structure, comprising:
filling a micropipette with a material having a selected index of refraction;
causing a portion of said material to exit at the tip of the micropipette to produce a protrusion; and
shaping the protrusion to form an optical element or mechanical element.

103. A method for fabricating a lens, comprising:
shaping a mold for use in forming a lens;
simulating the shape of the mold to define the structure, refractive index, and light modulating properties of the lens to be formed in the mold;
characterizing the shape of the mold by geometric and light profiling of the mold surface in the near field and the far field; and
iteratively shaping the mold while simulating and characterizing its shape.

104. The method of claim 103, further including forming multiple molds for use in fabricating a micro lens array.

105. A method for producing an optical waveguide, comprising:
simulating the parameters of the waveguide on the basis of a calculation of fields within the waveguide structure and outside a light emitting lens on the waveguide;
characterizing parameters of the lens by near-field and far-field geometric and light profiling of the lens; and
iteratively fabricating the waveguide and lens integrally with said simulating and characterizing the lens parameters.

106. The method of claim 105, further including:
integrating said near-field and far-field characterizing steps for testing waveguides and lenses and thus aiding in the mounting and integration of these devices with on-line motion and characterization.

107. A method of fabricating a multimode optical fiber transmitter or coupler to a single mode structure, including:
forming a tapered fiber and lens having a taper angle and radius of curvature, respectively, to provide a lens focus with high accuracy from the lens surface and having a waist diameter of about 3.8 microns.

108. A method in which extremely small spot size integral optical fiber lens are used to make a diffraction limited spot size and in which these devices can be cantilevered so that they could fit under the lens of a microscope or can be used as a straight lensed fiber so that a simple scanning integral lensed fiber based confocal (SILC) microscope can be built with the same piezo technology that is used for atomic force microscopes in order to replace complicated beam scanning confocal microscopes with much higher throughput, collection efficiency and resolution than conventional confocal beam scanners.

109. A method as in claim 108 in which a simple scanning integral lensed fiber based confocal (SILC) microscope can be built with the same piezo technology that is used for atomic force microscopes in order to replace complicated beam scanning confocal microscopes with much higher throughput, collection efficiency and resolution than conventional confocal beam scanners.

110. A method for producing a confocal microsope in which an optical fiber is placed in the scanner of an atomic force microscope at the eyepiece or some other port of the microscope and is used as the lens of the microscope for final focusing and collection.

111. A method as in claim 110, in which a fiber bundle is used.
